(19) United States
(12) Patent Application Publication
(10) Pub. No.: US 2022/0074792 A1
(43) Pub. Date: Mar. 10, 2022

(54) VISION ACCESSORY IN SUB-CEILING LAYER FOR AN INFRARED DETECTOR

(71) Applicant: CENTRE SCIENTIFIQUE ET TECHNIQUE DU BÂTIMENT (CSTB), CHAMPS-SUR-MARNE (FR)

(72) Inventors: Christophe MARTINSONS, LE TOUVET (FR); Pierre LEPRETRE, GRENOBLE (FR)

(21) Appl. No.: 17/419,975

(22) PCT Filed: Jan. 8, 2020
(86) PCT No.: PCT/EP2020/050312

§ 371 Date: Jun. 30, 2021

(30) Foreign Application Priority Data
Jan. 8, 2019 (FR) 1900160

(51) Int. Cl. G01J 5/00; G08B 13/193; G01J 5/08; G01J 5/04

(52) U.S. Cl. CPC G01J 5/0066; G08B 13/193; G02B 13/06; G01J 5/0815; G01J 5/04; G01J 5/0809

(57) ABSTRACT

An optical device for arrangement on a detector provided with an infrared sensor in order to modify the visual field of the detector. The device includes primary and secondary conical mirrors. The primary mirror collects the infrared radiation coming from a sub-ceiling layer around the device for returning it onto the secondary mirror which, itself, reflects it to the infrared sensor.

### TECHNICAL FIELD

The present invention relates to the field of optical systems comprising one or more optical components designed to reflect infrared radiation or cause such radiation to converge or to diverge.

The invention seeks more particularly to propose a simple and inexpensive optical device that allows the field of view of an infrared detector, ceiling-mounted in a room, to be modified with a view to observing the layer just below the ceiling in the room.

In another of its aspects, the invention also relates to an optical accessory that can be mounted on or removed from an existing infrared detector, the optical accessory comprising an optical device as mentioned.

The main application targeted by the invention is that of modifying the field of view of an infrared detector comprising a sensor of moderate resolution, comprising for example 64×64 or 80×80 sensitive elements. This type of detector has a resolution that is good enough to allow imaging applications.

Although described with reference to the main application, the invention applies to any type of infrared detector for which there is a need to modify the field of view of the detector in a way that is simple and inexpensive.

What is meant by the “layer just below the ceiling” or “sub-ceiling layer” is a layer situated directly beneath a ceiling of a room, and the thickness of which is small in comparison with the height of the room. Typically, a layer just below the ceiling has a thickness of less than 15% of the height of the room, directly beneath the ceiling.

### PRIOR ART

There are a number of technologies that can be used to manufacture sensors operating in the infrared domain. Thus, pyroelectric sensors and thermopiles are widely used for detectors of very low resolution, conventionally comprising just a few sensitive elements. Sensors incorporating microbolometers are employed in medium- and high-resolution sensors that can be used as imagers.

There is a growing interest in sensors of moderate resolution, which are able to implement basic imaging functions, such as locating an infrared source.

Such sensors may have a resolution comprised between 16×16 pixels and 80×80 pixels and may operate using one of the aforementioned technologies.

The execution of numerous functions of the very low-resolution detectors can be improved by the use of moderate-resolution sensors. In addition, this type of sensor allows new applications.

One of the main applications of existing infrared sensors, of pyroelectric type, is motion detection.

This is the principle employed for example in anti-intrusion detectors which are installed in a large number of buildings. An anti-intrusion alarm system typically relies on a pyroelectric sensor comprising two or four sensitive elements associated with a simple and cost-effective optical device that defines the field of view of the detector. This optical device may notably be a Fresnel lens array made of polyethylene or a collection of mirrors each made from a substrate made of a plastic such as polymethyl methacrylate (PMMA) or polycarbonate (PC), metallized at least on its functional surface.

An anti-intrusion detector of this type is qualified as a passive detector because it does not emit any radiation.

The operation of an anti-intrusion detector relies on observing a simultaneous variation in the ambient infrared flux received by all of the sensitive elements of the sensor.

There are a number of possible configurations for an anti-intrusion detector: ceiling-mounted, in which case the field of view is 360° in azimuth and typically of the order of around 45° in elevation, on each side of the vertical, or wall-mounted, in which case the field of view of the detector may be determined according to the configuration of the walls of the room in which it is installed.

Occupancy detectors, which usually control the automatic switching-on of lighting, are similar to anti-intrusion detectors in their operation.

There are also, in the case of fire-prevention alarms, detectors referred to as thermovelocimetric detectors which are sensitive to an abnormal increase in the temperature of the walls of a room, which characterizes the presence of a source of heat.

Although reliable, these detectors are limited insofar as they are unable to locate the source of heat.

In addition, a growing benefit for applications of counting individuals or managing queues of individuals waiting in line may be observed, for example for security or space-management reasons. In this context, the company Irisys has developed a pyroelectric sensor with a resolution of 16×16 pixels. This sensor, which can be installed for example above a queue of individuals waiting in line in a store, is associated with a lens made of germanium or of chalcogenide glass to obtain a field of view of limited angle, of the order of 50° to 60°. The resolution of the sensor, although relatively low, is nevertheless sufficient to obtain a good approximation of the number of individuals and of their location in the waiting line.

FIG. 1 schematically depicts an infrared detector 1 comprising an imager of moderate resolution and intended to be arranged on a ceiling. The infrared radiation enters the detector through the optical system 2, which notably comprises an input lens and an infrared sensor.

The angle α of the field of view of such a detector is conventionally comprised between 70° and 90°.

In a great many practical applications, the various aforementioned detector types are mounted on the ceiling of a room.

Now, the inventors have determined that there is a benefit to monitoring the layer just below the ceiling in a room.

This is because the layer just below the ceiling is of key importance in the comfort of a living space. This is notably the boundary layer for convection where a buildup of heat may occur, particularly in the summer.

Furthermore, cold spots may appear here, for example when windows are open in the winter. In other words, monitoring the layer just below the ceiling provides important information for the management of the thermal comfort of a room.

Furthermore, monitoring the layer just below the ceiling improves safety in the context of preventing or detecting an outbreak of fire. This is because it enables observation of the thermovelocimetry of the walls, namely the rate of change of wall temperature, and therefore allows an abnormal increase in wall temperature characteristic of a pre-fire situation to be detected. In addition, the buildup of hot smoke in the layer just below the ceiling in the event of a fire can also be detected.

By comparison with the existing fire-prevention detector solutions of which the field of view is pointed toward the floor of a room, a fire-prevention detector that is observing the layer just below the ceiling has the advantage of being unable to trigger an alarm on the basis of a false signal emanating for example from the occupants of the room or of hot objects that these occupants might be handling.

There is therefore a benefit in having a functionality whereby the layer just below the ceiling is monitored using infrared.

There are also in existence numerous infrared detectors that are already ceiling-mounted in a room, but the field of view of which is aimed toward the floor of the room.

There is therefore a need for a solution that allows the field of view of the existing detectors to be modified so that they monitor the layer just below the ceiling.

It is an object of the invention to at least partially address this need.

### DISCLOSURE OF THE INVENTION

In order to do this, one subject of the invention is an optical device, intended to be arranged on a detector equipped with an infrared sensor in order to modify the field of view of the detector, comprising:
a primary mirror of frustoconical overall shape, comprising a circular opening at its center,
a secondary mirror of conical overall shape,
at least one connecting means for connecting the primary mirror and the secondary mirror, so that the reflective surface of the primary mirror is arranged facing the reflective surface of the secondary mirror,

the primary and secondary mirrors being designed to reflect radiation in the infrared; and

the primary and secondary mirrors being configured to define the field of view of the device, to form an afocal system and to form a continuous image of the periphery of the device, the center of the image being hidden by the secondary mirror.

In the context of the invention, what is meant by the “periphery of the device” is all of the directions substantially perpendicular to the axis of symmetry of the cone of the primary mirror, delimiting a panoramic view.

Thus, the invention essentially consists in the use of two conical mirrors, the primary mirror collecting the infrared radiation from the layer just below the ceiling around the device to pass it on to the secondary mirror, which in turn reflects it to the sensor of the infrared detector.

The reflective surfaces of the mirrors are configured to perform this function.

Advantageously, the image obtained by the optical device according to the invention comprises a hidden center: specifically, the presence of the secondary mirror facing the central opening of the primary mirror has the effect of blocking infrared radiation coming up from the floor when the device is arranged on a detector that is mounted on the ceiling of a room.

The sensor therefore receives only the signals coming from the layer just below the ceiling: the floor and any occupants that the room might have are completely hidden.

The use of mirrors on the one hand makes it possible to avoid the use of costly infrared lenses, and on the other hand makes it possible to obtain an afocal reflective optic, thus avoiding optimization adjustments.

Furthermore, aspherical corrections of the image may advantageously be obtained.

By virtue of the invention, what is therefore obtained is a simple and inexpensive infrared optical device that makes it possible to modify the field of view of a detector and to produce a sharp and corrected image of the periphery of the device (which may be a layer just below the ceiling), with the floor hidden.

As a preference, the angle of the field of view is comprised between 5° and 10°. Thus, the field of view opens onto the layer just below the ceiling: it is only the infrared radiation coming from the layer just below the ceiling that is transmitted to the detector, this being over the entire periphery of the device, namely over 360° in azimuth.

According to one particular embodiment, the device is made up of a single piece of injection-molded plastic, such as polymethyl methacrylate (PMMA) or polycarbonate (PC), at least the surfaces of the primary mirror and of the secondary mirror being metalized.

As a preference, the maximum diameter of the primary mirror is less than 1010 mm, preferably less than 70 mm, and the height of the device in the direction of the axis of the cone defining the reflective surface is less than 40 mm, preferably less than 30 mm.

The invention also relates to an infrared detector comprising an optical device as described hereinabove, the device being arranged in such a way as to form the image on the infrared sensor of the detector.

The invention relates to the use of this infrared detector to detect a buildup of heat or a cold spot in the layer just below the ceiling of a room. It also relates to the use of this infrared detector to detect a buildup of hot smoke in the layer just below the ceiling or an abnormal change in the temperature of the walls of a room in the region of the layer just below the ceiling.

The invention finally relates to an optical accessory intended to be arranged on an infrared detector, comprising an optical device as described hereinabove and a mechanism for attaching the optical device to the infrared detector.

### BRIEF DESCRIPTION OF THE DRAWINGS

FIG. 1 is a schematic side view of an infrared detector according to the prior art;

FIG. 2 is a schematic view of an optical device according to the invention;

FIG. 3 is a view in longitudinal section of an optical device according to the invention, viewed in section;

FIG. 4 is a schematic view of an optical device according to the invention arranged on an infrared detector according to the prior art;

FIG. 5 is a side view of an optical device according to the invention arranged on an infrared detector according to the prior art;

FIG. 6 is an image obtained by an infrared detector according to the prior art;

FIG. 7 is a simulation of the image obtained by an infrared detector according to the prior art on which an optical device according to the invention is arranged.

### DETAILED DESCRIPTION

Throughout the present application, the terms “vertical”, “lower”, “upper”, “low”, “high”, “bottom” and “top” are to be understood with reference to an infrared detector in the configuration of operation mounted on a ceiling and facing toward the ground. Thus, in an operating configuration, the sensor of the infrared detector faces the ground in the vertical direction.

FIG. 1 has already been described in the preamble, and is therefore not commented upon hereinafter.

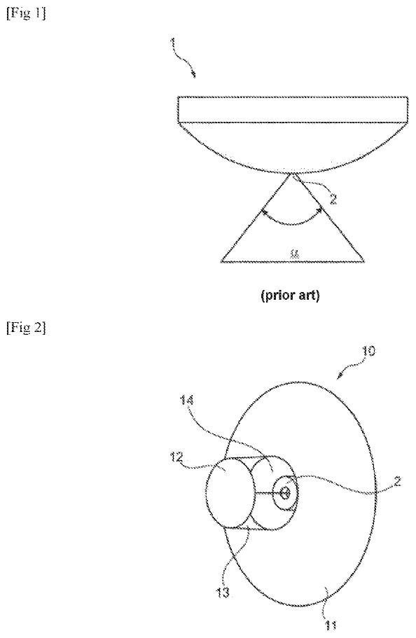

An optical device according to the invention is now described with reference to FIGS. 2 to 5.

The optical device 10 comprises a primary mirror 11, a secondary mirror 12 and connecting means 13 for connecting the primary mirror and the mirror.

In the embodiment illustrated, the connecting means 13 are rigid connecting means consisting of four supports of elongate shape distributed at equal angles, each attached by one of its ends to the primary mirror and by the other end to the secondary mirror.

The height of the optical device, namely its dimension in the vertical direction, may typically be of the order of 25 mm.

The primary mirror comprises a central opening 14 and a reflective surface 15.

Typically, the diameter of the primary mirror may be of the order of 60 mm.

The secondary mirror has a reflective surface 16. The reflective surface 16 of the secondary mirror is arranged facing the central opening 14 of the primary mirror.

Thus, from the viewpoint of the sensor, the secondary mirror 12 hides the floor, and only the radiation reflected by the secondary mirror enters the central opening 14 to reach the optical system 2 of the detector 1.

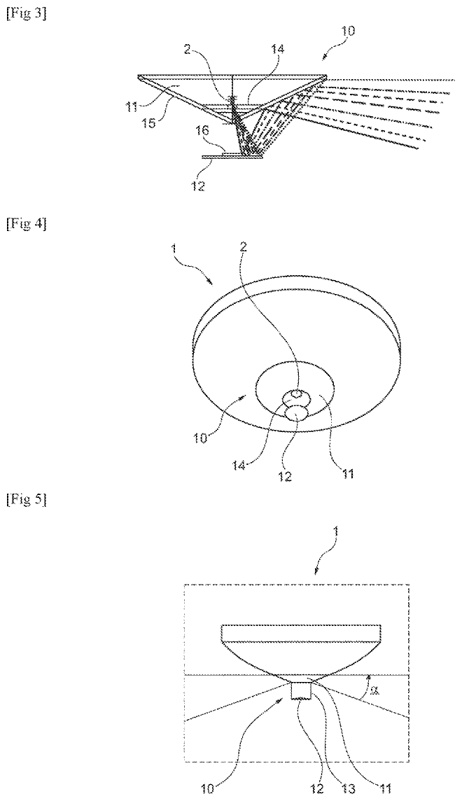

As is more clearly apparent in FIG. 3, which shows the optical lines of the infrared rays coming from the layer just below the ceiling, the reflective surfaces 15, 16 of the primary and secondary mirrors are of frustoconical and conical shape, respectively, and are configured to transmit to the optical system 2 of the detector the rays coming from the layer just below the ceiling.

The frustoconical profile of the primary mirror is such that the incident rays coming from the layer just below the ceiling are passed on to the secondary mirror, of which the profile is designed to reflect the rays onto the optical system 2 of the detector 1.

The field of view of the device extends continuously over 360° about the vertical and has a field angle α on the layer just below the ceiling of between 5° and 10°, as is more particularly visible in FIG. 5.

The mirrors are configured in such a way that the image formed on the sensor is sharp, with aspherical corrections.

Advantageously, the two mirrors form an afocal device.

The optical device 10 is preferably made as a single piece of injection-molded plastic, such as polymethyl methacrylate (PMMA) or polycarbonate (PC). The entire component, or at the very least the reflective surfaces of the mirrors, are then metalized so as to be able to reflect incident infrared radiation.

FIGS. 4 and 5 schematically depict an optical device 10 according to the invention arranged on an infrared detector 1.

Advantageously, the optical system 2 of the detector requires no modification and no electrical connections are necessary in order to arrange the optical device 10 on the detector 1.

In order to fix the optical device 10 to the detector 1, an attachment mechanism may be provided. This mechanism may for example comprise a semitransparent hemispherical dome made of polyethylene (PE) with a small thickness, typically close to 0.5 mm so as to effectively transmit the infrared radiation. The secondary mirror is secured to the internal face of the dome and this dome is attached to the base of the detector, thus covering the device.

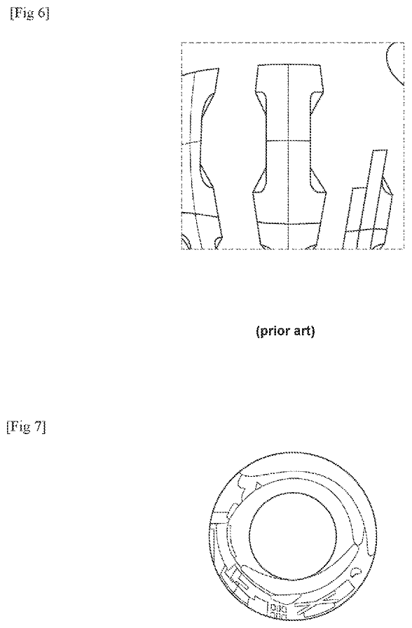

FIG. 6 is an image obtained by an infrared detector according to the prior art. The field of view of the detector is aimed toward the floor of the room, and its angle α does not exceed 90°.

FIG. 7 shows, for comparison, the result of a computer simulation reproducing the effect obtained by fitting an optical device according to the invention on the infrared detector used for obtaining the image of FIG. 6.

It may be seen that the field of view of the detector is modified and allows observation of the layer just below the ceiling. The floor in the center of the image is completely hidden because the secondary mirror blocks the field of view of the detector in the direction of the ground.

In the case of a fire-prevention detector, this hidden center makes it possible to avoid any risk of inappropriate triggering of the alarm by a false signal brought about for example by an occupant of the room or an object (for example a cup of coffee) that this occupant is handling.

Thus, by virtue of the invention, a simple, compact optical device containing no lenses can be used to modify the field of view of an infrared detector so as to observe the layer just below the ceiling.

This may notably be an accessory that is installed on an existing detector. Installing an optical device on an existing detector is easy: specifically, the original lens of the detector can still be used, no electrical connections are needed, and the positioning of the optical device does not require great precision.

The invention can be used to act as a fire alarm. Specifically, the infrared monitoring of the layer just below the ceiling allows the detection of hot smoke. It also enables observation of the thermovelocimetry of the walls of a room, namely the rate of increase in wall temperature, which is liable to indicate a pre-fire situation.

The invention may also be implemented with a view to improving thermal comfort in a room: infrared monitoring of the layer just below the ceiling may indicate a buildup of heat or enables detection of a window that has been left open when the outdoor weather conditions are wintry.

Other variants and advantages of the invention may be realized without thereby departing from the scope of the invention. The invention is thus not limited to the examples described hereinabove.

Although described with reference to the main target application, namely that of modifying the field of view of an infrared detector mounted on the ceiling of a room, the invention also applies to any field in which it is advantageous to modify the field of view of infrared viewing apparatus using a simple and inexpensive optical device in order to obtain a periscopic field of view.

Thus, the optical device described can also be used in the automotive and transport field.

1. An optical device, intended to be arranged on a detector equipped with an infrared sensor in order to modify a field of view of the detector, comprising:
a primary mirror of frustoconical overall shape, comprising a circular opening at its center,
a secondary mirror of conical overall shape,
at least one connecting means for connecting the primary mirror and the secondary mirror, so that a reflective surface of the primary mirror is arranged facing a reflective surface of the secondary mirror,
the primary and secondary mirrors being designed to reflect radiation in the infrared; and
the primary and secondary mirrors being configured to define a field of view of the device, to form an afocal system and to form a continuous image of a periphery of the device, a center of the image being hidden by the secondary mirror.

2. The optical device as claimed in claim 1, wherein the angle α of the field of view of the device is comprised between 5° and 10°.

3. The optical device as claimed in claim 1, wherein the optical device consists of a single piece of injection-molded plastic, at least the surfaces of the primary mirror and of the secondary mirror being metalized.

4. The optical device as claimed in claim 1, wherein a maximum diameter of the primary mirror is less than 100 mm, and a height of the device in a direction of an axis of a cone defining the reflective surface of the primary mirror is less than 40 mm.

5. An infrared detector comprising an optical device as claimed in claim 1, arranged in such a way as to form the image on the infrared sensor of the detector.

6. The use of the infrared detector as claimed in claim 5 to detect a buildup of heat or a cold spot in a layer just below a ceiling of a room.

7. The use of the infrared detector as claimed in claim 5 to detect a buildup of hot smoke in a layer just below a ceiling or an abnormal change in a temperature of walls of a room in a region of the layer just below the ceiling.

8. An optical accessory intended to be arranged on an infrared detector, comprising an optical device as claimed in claim 1 and a mechanism configured to attach the optical device to the infrared detector.
